(19) United States
(12) Patent Application Publication
(10) Pub. No.: US 2024/0389028 A1
(43) Pub. Date: Nov. 21, 2024

(54) PEER-TO-PEER COORDINATED TARGET WAKE TIME

(71) Applicant: Cisco Technology, Inc., San Jose, CA (US)

(72) Inventors: Ardalan ALIZADEH, Milpitas, CA (US); Vishal S. DESAI, San Jose, CA (US); Peiman AMINI, Fremont, CA (US)

(21) Appl. No.: 18/319,797

(22) Filed: May 18, 2023

(51) Int. Cl. H04W 52/02

(52) U.S. Cl. CPC H04W 52/0248; H04W 52/0216

(57) ABSTRACT

Embodiments described herein provide for target-wake-time (TWT) coordination in an enterprise network across multiple neighboring APs in order to provide for peer-to-peer (P2P) communications between peer network devices across a network, including across multiple basic services sets in the network.

### TECHNICAL FIELD

Embodiments presented in this disclosure generally relate to wireless communications. More specifically, to computer networks, and coordinating target wake time (TWT) schedules for localized wireless neighborhoods including peer-to-peer devices.

### BACKGROUND

Wireless networks are becoming increasingly ubiquitous, with many businesses, schools, and public areas now offering wireless connectivity to authorized users and to guests. With the increasing popularity of wireless networks, the number of different types of wireless clients and wireless protocols is also rapidly increasing. For example, personal devices now include cellular phones, tablets, and wearable devices (e.g., smart watches, head-mounted displays, etc.), while wireless protocol standards (e.g., Wi-Fi, 5G, etc.) and additional device capabilities, such as peer-to-peer communications, are also under continued development.

Target wake time (TWT), including restricted TWT (rTWT) protocols allow an access point (AP) (that provides wireless connectivity to personal devices) and clients of the AP to negotiate specific time windows for when clients are expected to wake up in order to communicate to the AP. TWT protocols may also be used to enable communication between peer-to-peer (P2P) devices; however, coordinating TWT in enterprise networks between P2P devices remains a challenge.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example communication network, according to embodiments described herein.

FIG. 2 illustrates an example wireless network that includes a first basic service set (BSS) and a second BSS, according to one embodiment described herein.

FIG. 3 is a system flow diagram for P2P discovery, according to one embodiment described herein.

FIG. 4 is a system flow diagram for P2P communication, according to one embodiment described herein.

FIG. 5 is method diagram for P2P discovery and communication, according to one embodiment described herein.

FIG. 6 is a system flow diagram for P2P authorization, according to one embodiment described herein.

FIG. 7 is a block diagram of a device for rTWT scheduling and P2P communication, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method. The method also includes receiving, at a first access point (AP) a peer-to-peer (P2P) communication request from a first device connected to a first access point (AP) in a first basic service set (BSS) and requesting to communicate with a second device in a second BSS via P2P communication; negotiating, with a second AP in the second BSS, a P2P authorization may include a restricted target wait time (rTWT) schedule for P2P communication between the first device and the second device; and providing the P2P authorization to the first device to activate P2P communication between the first device and the second device. Other embodiments of this aspect include corresponding computer systems, apparatus, and computer programs recorded on one or more computer storage devices, each configured to perform the actions of the methods.

One general aspect includes an access point (AP). The access point also includes a processor; and a memory may include instructions which, when executed on the processor, performs an operation. The operation may include: receiving, at a first access point (AP) a peer-to-peer (P2P) communication request from a first device connected to a first access point (AP) in a first basic service set (BSS) and requesting to communicate with a second device in a second BSS via P2P communication; negotiating, with a second AP in the second BSS, a P2P authorization may include a restricted target wait time (rTWT) schedule for P2P communication between the first device and the second device; and providing the P2P authorization to the first device to activate P2P communication between the first device and the second device. Other embodiments of this aspect include corresponding computer systems, apparatus, and computer programs recorded on one or more computer storage devices, each configured to perform the actions of the methods.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method. One general aspect includes a method. The method also includes detecting, at a network device associated with a first basic service set (BSS), a peer device within peer-to-peer (P2P) connection distance is associated with a second BSS different from the first BSS; transmitting a P2P request to an access point (AP) of the first BSS; receiving, at the network device from the AP, a P2P authorization may include a restricted target wait time (rTWT) schedule; and communicating with the peer device via P2P communications during the rTWT schedule. Other embodiments of this aspect include corresponding computer systems, apparatus, and computer programs recorded on one or more computer storage devices, each configured to perform the actions of the methods.

### EXAMPLE EMBODIMENTS

With the increase of mobile devices (e.g., smart phones, tablet devices, etc.), Internet of Things (IoT) devices, and non-stationary network connected devices, the use of wireless networks to provide network connections has also increased. As the various types of wireless network connected devices increase, the types of applications executing on the devices has also increased. Coordinating communication across these large number of devices and various applications remains a challenge. Additionally, a large number of these device may utilize direct or peer-to-peer (P2P) communication between two devices which increases the complexity of the communication coordination in a wider network.

Some networks, including Wi-Fi networks provide for TWT scheduling which allows an access point (AP) (that provides wireless network connectivity to personal devices) and clients of the AP to negotiate specific time windows for when clients are expected to wake up in order to communicate to the AP. TWT provides for optimization of service in Wi-Fi-based networks that offer it. Further, because TWT offers power saving opportunities, many network devices are likely to heavily utilize this feature in order to preserve energy at the devices and to provide non-conflicting P2P communications. Additionally, restricted TWT (rTWT) negotiation mechanisms may provide for use of an entire rTWT window for P2P transmission upon client/device request. This provides a deterministic channel usage for P2P to better support time sensitive applications and minimize traffic contention for P2P communication. However, these systems and protocols are limited in providing P2P communication across BSSs in a wider network. The systems and methods described herein provide for TWT coordination in an enterprise network across multiple APs in order to provide for P2P communications across a network and improve the reliability and functioning of the Wi-Fi network.

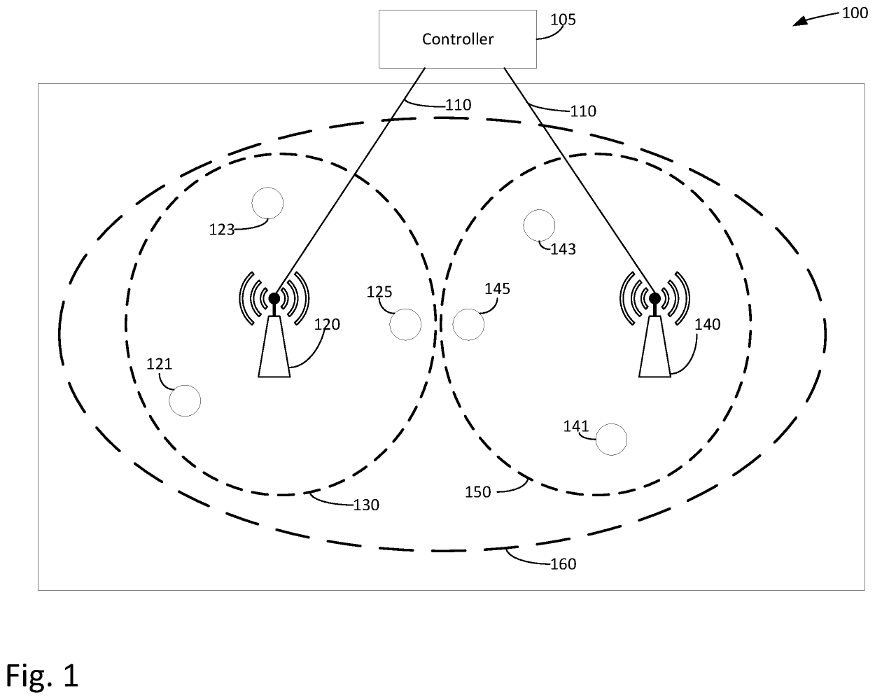

FIG. 1 illustrates a network 100, according to one embodiment described herein. The network 100 includes a network controller 105, AP 120, and AP 140. The network 100 also includes network devices 121, 123 and 125 in a BSS 130 and connected to the AP 120. Network devices 141 and 143 and peer device 145 are in a BSS 150 and to the AP 140. In some examples, the network 100 is a Wi-Fi 8 (or other similar network protocol) wireless local area network (WLAN) providing network connection to the APs 120 and 140 and the various connected network devices. For example, network device 125 and peer device 145 are Wi-Fi devices connected to the respective APs as part of a basic service set (BSS) for network connections in the network 100 and external networks. In some examples, the devices include a variety of devices such as user devices (e.g., mobile phones, laptops, etc.), IoT devices (e.g., smart devices, etc.), and other similar client or network devices which are also capable of P2P communications.

In general, one way of communicating between two peer devices includes off-channel communications. For example, the P2P devices may leave a serving channel between the device and the AP and communicate with each other in another channel and come back to the serving channel upon completion of the P2P communication. In some examples, the associated AP would not have control on the process and the device may be disassociated (session time out) once the device attempts to come back to serving channel connected to the AP. Additionally, there is no guarantee that the off-channel is less occupied and in an extended service set (ESS) it may cause extra unmanaged interference to other BSS.

In the systems and methods described herein, the network devices and APs provide deterministic channel access by taking the advantage of rTWT extended in P2P use-cases for Wi-Fi including Wi-Fi 7 and Wi-Fi. In these examples, the peer devices communicate with each other via a reserved/shared transmission opportunity (TXOP) from both BSS's.

In some examples, TWT or restricted TWT (rTWT) scheduling allows a network device to negotiate a wakeup schedule with an AP that the client is associated with, where the network device can sleep for a defined duration and wake up to communicate with the AP and or a peer device for a relatively short scheduled service period at agreed intervals of time. The AP negotiates the wakeup schedule for an individual network device or group of network devices. With high data traffic, rTWT scheduling allows the AP to manage contention for time resources in a single BSS by splitting the time resources among the clients that would otherwise attempt to access the medium all at the same time (which would lead to reduced media access control (MAC) efficiency).

In a high-density situation where a large number of such P2P devices are connected, managing resources (e.g., time, spectrum, etc.) may become a difficult task. Furthermore, any disruption in an AP's scheduled service on the resources (e.g., on the channel) may collide with possibly many scheduled rTWT windows (e.g., by other APs or network devices) and result in loss of service to clients of the AP. The loss of service to the clients can only be resumed in a future rTWT window (when the AP is scheduled to provide the service). In some examples, the network controller 105, APs 120 and 140 and the devices/nodes may utilize rTWT schedules to negotiate specific time windows during which the devices/nodes are expected to wake up (e.g., activate antennas and/or radio component(s)) in order to communicate with the APs 120 and 140 or with a peer devices as described in more detail herein.

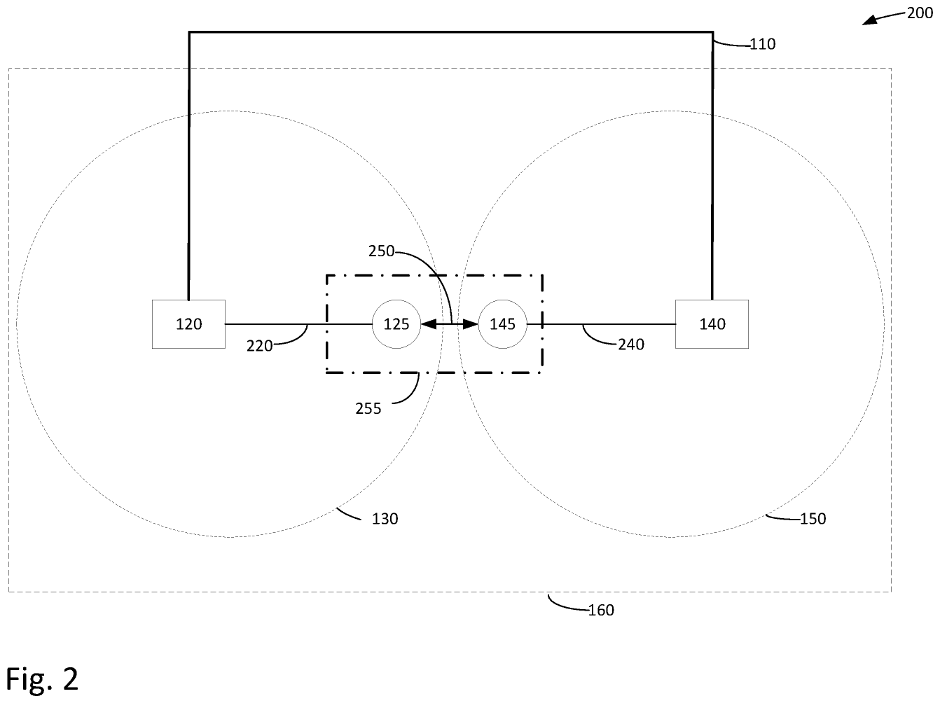

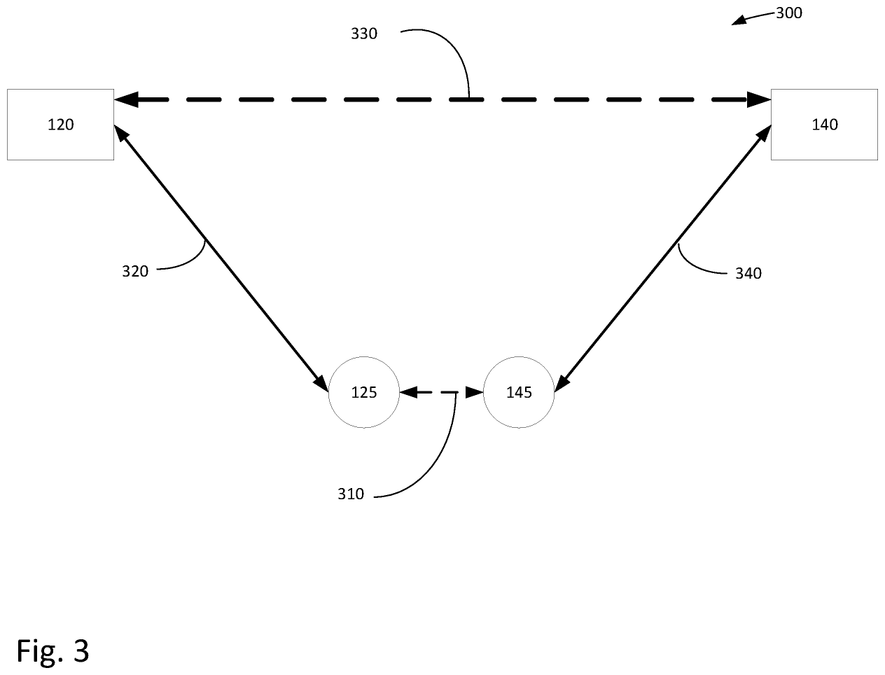

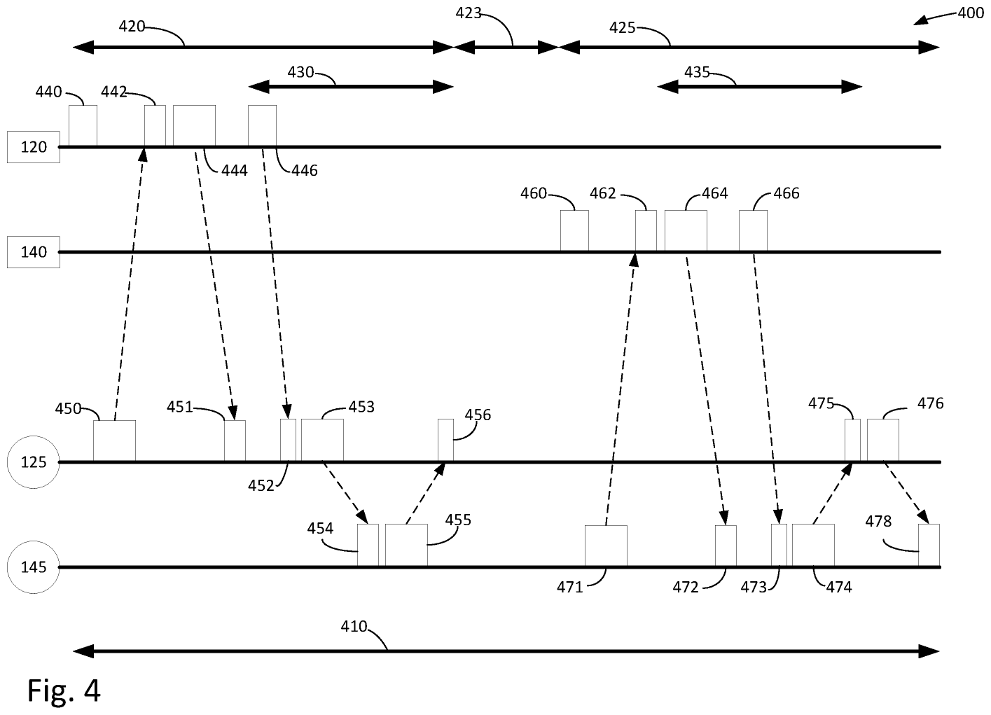

FIG. 2 illustrates an example wireless network 200 that includes a first BSS and a second BSS, according to one embodiment described herein. FIG. 3 is a system flow diagram for P2P discovery, according to one embodiment described herein. FIG. 4 is a system flow diagram for P2P communication, according to one embodiment described herein. For ease of illustration and discussion, methods 500 and 600 will be discussed in parallel with FIGS. 1-4.

Method 500 begins at block 510, where a network device, such as the network device 125 detects, a peer device within P2P connection distance. For example, with reference to FIGS. 2 and 3, the network device 125 is capable of P2P communications with devices within a P2P connection distance or within a proximity 255 of the network device 125, including peer device 145. In some examples, the network device 125 is associated with a first BSS, such as the BSS 130 and the peer device 145 is associated with a second BSS different from the first BSS, such as the BSS 150. While the P2P devices are in different BSSs, the BSS 130 and the BSS 150 are both a part of the ESS 160. At step 310, the network device 125 detects the peer device 145 and determines that P2P communication is possible, but that the peer device 145 is in the BSS 150.

In some examples, during P2P discovery processes both devices use the same BSS and this status can be simply used as an indicator for the possibility of P2P usage when one device requests P2P communication with another device. In some examples, such as when the devices are in differing BSSs, the network device detects that the desired peer is associated to a neighbor AP (e.g., the AP 140).

In some examples, realization of any P2P usually requires a local application or central/cloud control to initialize and maintain the data transfer. For example, virtual or alternate reality (VR/AR) headsets (or any other appliances such as smart TVs) may request P2P communications to a neighbor device such as a smart phone/laptop, etc. In each of these cases, the user and associated network device is in the vicinity of the peer device and requests for such connectivity. In some examples, the network device 125 considers the service set identifier (SSID) of the BSSs and/or a location of devices as additional metric to identify the presence of requested peer in the proximity 255.

Additionally, in some examples, the network device 125 is connected to the first AP via a first channel, channel 220, and the peer device connected to a second AP via a second channel, channel 240 different from the first channel. For example, the different channels of the differing BSSs reduces a risk of traffic inference between the various clients in the respective BSSs.

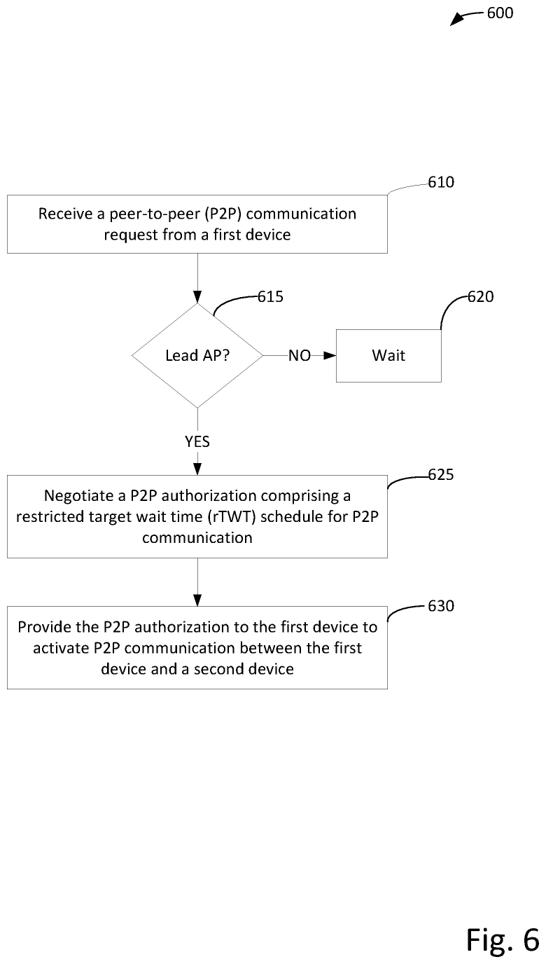

Returning back to method 500, at block 515 the network device 125 transmits a P2P request to an AP of the first BSS. For example, the network device 125 transmits a P2P request to the AP 120 at step 320 of FIG. 3 via the first channel, channel 220. In some examples, the AP 120 negotiates a P2P authorization step 330 and via the connection 110, as described in more detail in relation to method 600 of FIG. 6.

For example, method 600 begins at block 610, where the AP 120 receives a peer-to-peer (P2P) communication request from a first device connected to a first access point (AP) in a first basic service set (BSS). For example, at step 320, the AP 120 receives the P2P request the network device 125 to communicate with a second device, such as the peer device 145, in a second BSS via P2P communication. In some examples, the first BSS and the second BSS are in a same extended service set (ESS).

At block 615, the AP 120 determines whether the AP is a designated lead. In an example, where the AP 120 is not a lead AP, the method 600 proceeds to block 620, where the AP 120 waits for a lead AP to lead a negotiation for P2P communications.

In another example, where the AP 120 is the lead AP, method 600 proceeds to block 625, where the AP 120 negotiates, with a second AP in the second BSS, a P2P authorization including an rTWT schedule for P2P communication between the first device and the second device. In some examples, the AP 120 may inspect a shared P2P device list at the AP 120 for the second device and upon determining the second device is in the shared P2P list, selecting a predefined P2P authorization as the P2P authorization (i.e., a P2P negotiation has already taken place between the APs for the second device). In some examples, multi-AP coordination in MAC layer provides the P2P devices information to the lead AP, i.e. AP 120. In some examples, the APs 120 and 140 are time-synchronized and the beacons are being transmitted at the same time. At block 630, the AP 120 provides the P2P authorization to the first device to activate P2P communication between the first device and the second device.

In some examples, the network device 125 requests P2P communication to peer device 145 the AP 120 and the AP 120 requests identification of clients of the neighbor APs, including the AP 140. In some examples, the AP 120 requests the information via the network controller 105 and/or any MAC layer defined in multi-AP coordination schemes. In some examples, the network device 125 transmits a P2P solicited frame and the AP 120 acts as designated lead AP and sends the P2P request to the AP 140 which relays the request to the peer device 145 at step 340. The peer device 145 accepts the P2P request from the network device 125. In some examples, the discovery process of the system flow 300 provides the respective channel numbers of the network device 125 and peer device 145. In some examples, the AP 120 provides the neighbor P2P clients via a multi-user request to send (MU-RTS) TXS Trigger frame at the beginning of each reserved TXOP as shown in more detail in relation to FIG. 4. This frame may also include the channel and TWT service period (SP).

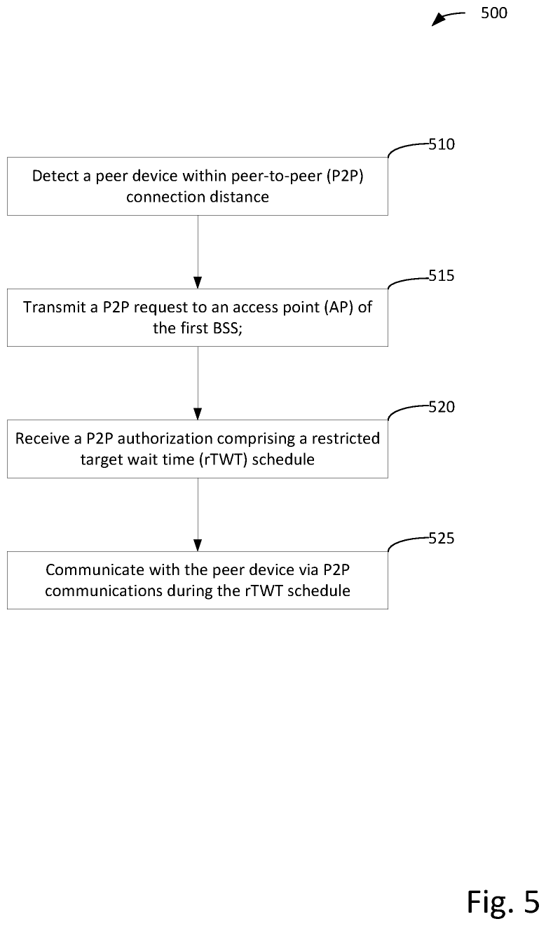

Returning back to FIG. 5, at block 520, the network device 125 receives the P2P authorization from the AP 120. In some examples, the P2P authorization includes an rTWT schedule such as shown in FIG. 4. The rTWT schedule may also include service period (SP) information for P2P communication between the network device and the peer device. The SP information identifies a first SP for the first channel and a second SP for the second channel.

At block 525, the network device 125 communicates with the peer device via P2P communications during the rTWT schedule. In some examples, the network device communicates P2P traffic between the network device and the peer device via the first channel during a first transmit opportunity (TXOP) in the first SP and communicates P2P traffic between the network device and the peer device via the second channel during a second TXOP in the second SP. The network device may also pause P2P traffic communication and other communications between the first SP and the second SP to provide for channel switching at the network device and the peer device.

For example, system flow 400 in FIG. 4 includes communications between the devices, including AP 120, AP 140, network device 125, and peer device 145. The system flow 400 includes the rTWT schedule, which includes a rTWT window 410 for communications. The rTWT window 410 includes SP 420 for channel 220 rTWT, an SP pause, SP 423, for channel switching, and SP 425 for channel 250 rTWT. The SP 420 includes TXOP 430 and the SP 425 includes TXOP 435.

At step 440, after P2P discovery of the system flow 300 described above, the AP 120 generates and broadcasts a trigger frame indicating the beginning of the rTWT window 410 and SP 420. At step 450, the network device 125 begins communication with the AP 120 by transmitting data to the AP 120 which, in turn, generates a block acknowledgement (BA) at step 442. At steps 444 and 451, the AP 120 transmits data to the network device 125, which in turn generates a BA at the step 451. At step 446, the AP 120 transmits a MU-RTS TXS Trigger to the network device 125, which generates a Clear to Send (CTS) frame at step 452.

The network device 125 and peer device 145 communicate data via the first channel in the TXOP 430 at steps 453, 454, 455, and 456. In some examples, during the SP 423, the devices stop transmitting frames while the network device 125 and the peer device 145 switch from channel 220 to channel 240 for further communication.

At step 460, the AP 140 generates and broadcasts a trigger frame indicating the beginning of the SP 425. At step 471, the peer device 145 begins communication with the AP 140 by transmitting data to the AP 140 which, in turn, generates a block BA at step 462. At steps 464 and 472, the AP 140 transmits data to the peer device 145, which in turn generates a BA at the step 472. At step 466, the AP 120 transmits a MU-RTS TXS Trigger to the peer device 145, which generates a CTS frame at step 473. The network device 125 and peer device 145 communicate data via the second channel in the TXOP 5 at steps 474, 475, 476, and 478.

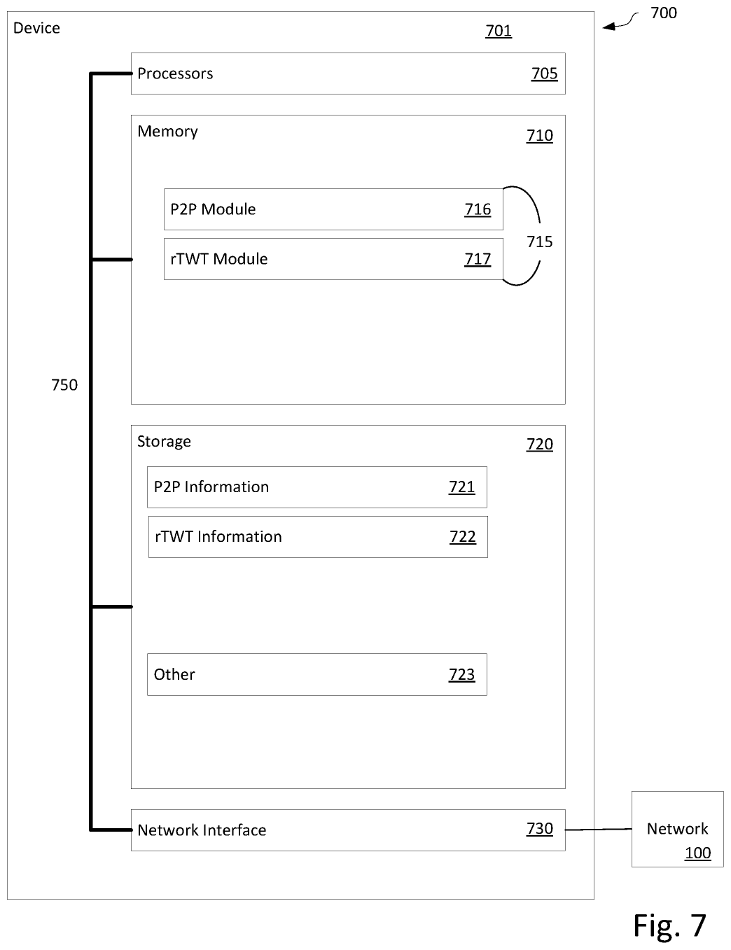

FIG. 7 is a block diagram of a device for rTWT scheduling and P2P communication, according to one embodiment. Arrangement 700 may include device 701, which may take the form of the AP 120 or the network device 125, and is configured to execute the various functions of authorizing and activating P2P between peer devices in a wireless network as described herein. The device 701 is shown in the form of a general-purpose computing device, but may include a server, device, and/or application executing on a cloud network. The components of device 701 may include, but are not limited to, one or more processing units or processors 705, a system memory 710, a storage system 720, network interface 730 connecting the device 701 to the network 100, and a bus 750 that couples various system components including the system memory 710 and storage system 720 to processors 705 along with various input/output components (not shown). In other embodiments, arrangement 700 is distributed and includes a plurality of discrete computing devices that are connected through wired or wireless networking.

Bus 750 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Device 701 typically includes a variety of computer system readable media (e.g., a non-transitory computer-readable storage medium). Such media may be any available media that is accessible by device 701, and it includes both volatile and non-volatile media, removable and non-removable media.

System memory 710 can include computer system readable media in the form of volatile memory, such as random access memory (RAM) and/or cache memory. Device 701 may further include other removable/non-removable, volatile/non-volatile computer system storage media. By way of example, storage system 720 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a Compact Disc Read-Only Memory (CD-ROM), digital versatile disc-read only memory (DVD-ROM) or other optical media can be provided. In such instances, each can be connected to bus 750 by one or more data media interfaces. As will be further depicted and described below, system memory 710 may include at least one program product having a set (e.g., at least one) of program modules that are configured to carry out the functions of various embodiments described herein.

Device 701 may further include other removable/non-removable, volatile/non-volatile computer system storage media. In some examples, storage system 720 may be included as part of system memory 710 and may typically provide a non-volatile memory for the networked computing devices, and may include one or more different storage elements such as Flash memory, a hard disk drive, a solid state drive, an optical storage device, and/or a magnetic storage device. For example, storage system 720 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 750 by one or more data media interfaces. Storage system 720 may include media for P2P information 721, rTWT information 722, and other information 723 stored for access and use by the device 701.

The system memory 710 may include a plurality of program modules 715 for performing various functions described herein. The program modules 715 generally include program code/program instructions that is executable by one or more of the processors 705. As shown, program modules 715 include P2P module 716 and rTWT module 717. The program modules 715 may also interact with each other and storage system 720 to perform certain functions as described herein.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
receiving, at a first access point (AP) a peer-to-peer (P2P) communication request from a first device connected to the first AP in a first basic service set (BSS) and requesting to communicate with a second device in a second BSS via P2P communication;
negotiating, with a second AP in the second BSS, a P2P authorization comprising a restricted target wait time (rTWT) schedule for P2P communication between the first device and the second device; and
providing the P2P authorization to the first device to activate P2P communication between the first device and the second device.

2. The method of claim 1, wherein first BSS and the second BSS are in a same extended service set (ESS).

3. The method of claim 1, wherein the first device is connected to the first AP via a first channel and the second device is connected to the second AP via a second channel different from the first channel, wherein the rTWT schedule comprises service period (SP) information for P2P communication between the first device and the second device, wherein the SP information identifies a first SP for the first channel and a second SP for the second channel.

4. The method of claim 3, wherein the P2P authorization further comprises:
a first transmit opportunity (TXOP) in the first SP for P2P traffic between the first device and the second device via the first channel; and
a second TXOP in the second SP for P2P traffic between the first device and the second device via the second channel.

5. The method of claim 4, wherein the P2P authorization further comprises
a SP pause between the first SP and the second SP to provide for channel switching at the first device and the second device.

6. The method of claim 1, wherein the first AP is a designated lead AP for negotiating the P2P authorization.

7. The method of claim 1, wherein negotiating the P2P authorization comprises
inspecting a shared P2P device list for the second device; and
upon determining the second device is in the shared P2P list, selecting a predefined P2P authorization as the P2P authorization.

8. An access point (AP), comprising:
a processor; and
a memory comprising instructions which, when executed on the processor, performs an operation, the operation comprising:
receiving, at a first access point (AP) a peer-to-peer (P2P) communication request from a first device connected to the first AP in a first basic service set (BSS) and requesting to communicate with a second device in a second BSS via P2P communication;
negotiating, with a second AP in the second BSS, a P2P authorization comprising a restricted target wait time (rTWT) schedule for P2P communication between the first device and the second device; and
providing the P2P authorization to the first device to activate P2P communication between the first device and the second device.

9. The AP of claim 8, wherein first BSS and the second BSS are in a same extended service set (ESS).

10. The AP of claim 8, wherein the first device is connected to the first AP via a first channel and the second device is connected to the second AP via a second channel different from the first channel, wherein the rTWT schedule comprises service period (SP) information for P2P communication between the first device and the second device, wherein the SP information identifies a first SP for the first channel and a second SP for the second channel.

11. The AP of claim 10, wherein the P2P authorization further comprises:
a first transmit opportunity (TXOP) in the first SP for P2P traffic between the first device and the second device via the first channel; and
a second TXOP in the second SP for P2P traffic between the first device and the second device via the second channel.

12. The AP of claim 10, wherein the P2P authorization further comprises
a SP pause between the first SP and the second SP to provide for channel switching at the first device and the second device.

13. The AP of claim 8, wherein the first AP is a designated lead AP for negotiating the P2P authorization.

14. The AP of claim 8, wherein negotiating the P2P authorization comprises
inspecting a shared P2P device list for the second device; and
upon determining the second device is in the shared P2P list, selecting a predefined P2P authorization as the P2P authorization.

15. A method, comprising:
detecting, at a network device associated with a first basic service set (BSS), a peer device within peer-to-peer (P2P) connection distance is associated with a second BSS different from the first BSS;
transmitting a P2P request to an access point (AP) of the first BSS;
receiving, at the network device from the AP, a P2P authorization comprising a restricted target wait time (rTWT) schedule; and
communicating with the peer device via P2P communications during the rTWT schedule.

16. The method of claim 15, wherein first BSS and the second BSS are in a same extended service set (ESS).

17. The method of claim 15, wherein the network device is connected to the AP via a first channel and the peer device connected to a second AP via a second channel different from the first channel, wherein the rTWT schedule comprises service period (SP) information for P2P communication between the network device and the peer device, wherein the SP information identifies a first SP for the first channel and a second SP for the second channel.

18. The method of claim 17, wherein communicating with the peer device via P2P communications further comprises:
communicating P2P traffic between the network device and the peer device via the first channel during a first transmit opportunity (TXOP) in the first SP; and
communicating P2P traffic between the network device and the peer device via the second channel during a second TXOP in the second SP.

19. The method of claim 18, further comprising:
pausing P2P traffic communication between the first SP and the second SP to provide for channel switching at the network device and the peer device.

20. The method of claim 15, wherein the AP is a designated lead AP for negotiating the P2P authorization.
